(19) United States
(12) Patent Application Publication
(10) Pub. No.: US 2021/0186786 A1
(43) Pub. Date: Jun. 24, 2021

(54) CONTAINER

(71) Applicant: HYGIENIUS INTELLECTUAL PROPERTY B.V., Breukelen (NL)

(72) Inventor: Ian Alexander WEBB, London (GB)

(21) Appl. No.: 17/263,056

(22) PCT Filed: Jul. 15, 2019
(86) PCT No.: PCT/NL2019/050444

§ 371 Date: Jan. 25, 2021

(30) Foreign Application Priority Data
Jul. 26, 2018 (NL) 2021396

(51) Int. Cl. A61G 9/00

(52) U.S. Cl. CPC A61G 9/00; A61G 2203/76; A61G 9/006

(57) ABSTRACT

The present invention relates to a single use, non-expandable, disposable container for holding a liquid, in particular a body liquid, the container comprising: —a bottom wall, —a circumferential side wall which extends in an upward direction from the bottom wall, wherein the circumferential side wall defines an upper opening ( ) at an upper end ( ) of the container, —a first folding flap and a second folding flap which are connected via a respective first folding line and a second folding line to opposed sections of an upper edge of the circumferential side wall, wherein the first and second folding flaps are foldable between an open position and a closed position, wherein in the open position of the folding flaps the circumferential side wall and the folding flaps taper outwardly in an upward direction, allowing the container to be nested, and wherein the folding flaps have a varying flap width, wherein the flap width reaches a maximum at a central portion of the folding flaps, and wherein said maximum flap width is smaller than a bottom width of the bottom wall, wherein during the folding of the folding flaps the folding flaps are deformed, wherein when seen in front view, during the folding of the folding flaps from the open position to the closed position, the circumferential side wall deforms from the outwardly tapering form to an inwardly tapering form.

### FIELD OF THE INVENTION

The present invention relates to the field of single use, disposable containers for holding a volume of liquid, in particular containers for holding body liquids such as urine or vomit. The container is in particular to be used in a healthcare environment, in particular in a hospital or long term care environment.

### BACKGROUND OF THE INVENTION

Single-use, disposable containers for holding a liquid are known, and many documents exist which describe such containers. However, it was found in the present invention that many requirements apply to the practical usability of such containers, in particular when used in a healthcare environment, and that no container exists which complies with all these requirements.

Important requirements which apply to such a container are that the container is cheap, simple in use, and reliable in the sense that it does not leak.

Furthermore, the container it should be easily disposable and for that reason should be manufactured from a material which is disposable without a need of complicated machinery for shredding the container and without harm to the environment. Cardboard is a suitable material for this purpose.

Another requirement is that the container should be capable of being nested, in order to be stored in large numbers without requiring a large storage volume. To this end, collapsible containers are known which can be expanded prior to use. However, such containers have an inherent disadvantage that the user should expand container before use, which requires attention and a certain level of skill. Non-collapsible containers have an advantage in this respect and are preferable in certain conditions. The present invention relates in particular to a non-collapsible container (or rather to a container which does not need to be expanded prior to use).

Another requirement is that the container should be portable after use, in other words when the container is filled with a liquid, a user should have the opportunity to carry the filled container to a disposal location without a significant risk of spilling the liquid which is held inside the container.

Another requirement which applies in particular to containers intended to be used as a urinal is that it should have certain ergonomic features. A container which is to be placed between the legs of a user should have certain dimensions which make this possible. In particular the width of the container should be limited, or otherwise the container does not fit very well between the legs of a user.

Another requirement which applies to containers which are intended to be used as a urinal is that it should be free of sharp edges as much as possible, because sharp edges inherently bring the risk of cutting body parts of the user, in particular the private parts.

The above two requirements also apply to containers which are used to catch vomit, although to a lesser extent.

A further requirement which applies in particular to a urinal is that during use, a user should be capable of holding the urinal in position, preferably with a single hand. After use, a user should be capable of lifting the urinal from the position between his or her legs in an easy manner, and preferably by using only a single hand.

Another requirement which applies to containers which are intended to be used as a urinal and to containers intended for catching vomit is that they should be able to hold a certain minimal volume of liquid, or else the urine or vomit will spill over during the filling of the container.

Another requirement which applies to containers which are intended to be used as a urinal and to containers intended for catching vomit is that they should be able to stand upright in a stable manner, with a minimal risk of toppling over, which would result in spilling the urine or vomit.

Another requirement which applies to containers which are intended to be used as a urinal is that the pee opening should be accessible by the user. The user should in particular be easily capable of inserting his penis into the pee opening (in case of a male), or positioning the pee opening very close to the vagina (in case of a female). The container as described by the invention enables a visual access into the container to properly position the container when the user is sitting slightly upright in a bed. This reduces the chance of spilling of urine.

It was found that no urinal exists which complies with all these requirements.

US2015/0021382A1 discloses a container which appears to be stackable and disposable. A problem with this container is that it wider at the top than at the bottom. This makes it difficult for a user to carry the urinal with a single hand, because when the hand is placed over the upper end of the container, it is difficult to grasp both sides of the container. Obviously, if the container would be very small this problem would not be present, but such a small size would make the container unsuitable for many purposes. The container of US2015/0021382A1 is also not a urinal, nor is there any suggestion that it could be modified in order to be used as a urinal.

US2015/0272361A1 discloses a container which is similar to the container according to US2015/0021382A1 and which has a similar problem.

US2014042217 discloses a drink cup having a similar shape as the containers of US2015/0272361A1 and having a similar problem.

WO2013175020A1, GB2380397A and GB773138A also disclose similar containers having a similar problem. Either the volume is too small or the container cannot be held at the top end with a single hand.

### OBJECT OF THE INVENTION

It is an object of the present invention to provide a single-use, disposable container which does not need to be expanded prior to use and which complies with the above indicated requirements.

### SUMMARY OF THE INVENTION

In an embodiment, a single use, non-expandable, disposable container for holding a liquid, in particular a body liquid, is provided, the container comprising:
a bottom wall,
a circumferential side wall which extends in an upward direction from the bottom wall, wherein the circumferential side wall defines an upper opening at an upper end of the container,
a first folding flap and a second folding flap which are connected via a respective first folding line and a second folding line to opposed sections of an upper edge of the circumferential side wall, wherein the first and second folding flaps are foldable between an open position in which the upper opening is open and a closed position in which the upper opening is substantially closed and in which the first and second folding flap are folded over another,
wherein in the open position of the folding flaps the circumferential side wall and the folding flaps taper outwardly in an upward direction and the folding flaps are substantially aligned with the circumferential side wall, allowing the container to be nested, and
wherein the container has a front side, a rear side a right side and a left side, wherein in the closed position of the folding flaps the upper end of the container has a concave shape,
wherein during the folding of the folding flaps from the open position to the closed position the folding flaps are deformed.

In an embodiment, when seen in front view, during the folding of the folding flaps from the open position to the closed position, the circumferential side wall may deform from the outwardly tapering form to an inwardly tapering form.

As a result from the deformation from outwardly tapering to inwardly tapering, the container is nestable (stackable) and can be large enough to hold a significant volume, in particular a volume sufficient for the container to be used as a urinal, while at the same time having an upper end which is sufficiently narrow so that a user can hold the container with a single hand by placing his thumb on one side while placing his fingers on the opposite side and holding the container by pressing his thumb and his fingers together.

Also, the inward tapering make the container suitable to be held between the legs and a mattress or chair on which the user is located. The container cannot move upwards because the legs engage the inward tapering circumferential side wall. The container can also not move downward, because it rests on the mattress or chair (or other surface).

The container according to the invention also complies with the other requirements mentioned in the section “Background to the invention”.

The flaps may be deformed by reversing the curvature when closing the flaps. In the open position the outer side of the flaps may be convex and in the closed position, the outer side (which is now the upper side) may be concave.

In an embodiment, when seen in front view in the open position of the folding flaps the tapering angle of the circumferential side wall may be 3-7 degrees outward and wherein in the closed position of the folding flaps the tapering angle of the circumferential side wall may be 3-20 degrees inward. The outward angle of 3-7 degrees makes the container suitable to be stacked, while the inward tapering angle of 3-20 degrees makes the container narrow enough at the top to be held with a single hand.

In an embodiment, in the open position of the folding flaps the bottom wall and the lower edge of the circumferential side wall have a rocker shape when seen in side view of the container, wherein during the folding of the folding flaps from the open position to the closed position the bottom wall and the lower edge of the circumferential side wall are deformed from the rocker shape into a substantially flat shape and wherein in the open position of the folding flaps the bottom wall and the lower edge of the circumferential side wall have a camber shape when seen in front view of the container, wherein during the folding of the folding flaps from the open position to the closed position the bottom wall and the lower edge of the circumferential side wall are deformed from the camber shape into a substantially flat shape.

This embodiment provides the advantage that the container has a flat base when the folding flaps are in the closed position and as a result of this can stand stable on a surface. Also, a benefit of ensuring that the base is flat when the flaps are closed is that a liquid fill level marking, if present, will be more accurate. This may help reduce the need for decanting the urine or for weighing.

In an embodiment, the folding flaps may have a maximum flap width which is smaller than a maximum bottom width of the bottom wall. This feature assists in deforming—when seen in front view—the circumferential side wall from the outwardly tapering form to an inwardly tapering form during the folding of the folding flaps from the open position to the closed position.

In an embodiment, a maximum width of the folding flaps may be between 7 and 9 cm, and wherein a maximum width of the bottom wall may be greater than 10 cm. This provides the advantage of a sufficient volume and a narrow upper end of the container when the flaps are in the closed position.

In an embodiment, the container may be a urinal and comprise a pee opening in the front side. The urinal provides several advantages, including an ergonomic shape which allows the urinal to be positioned between the legs of a user. An important advantage of the urinal having the top flaps is that the open upper end (prior to closing of the flaps) allow the user to ‘self position’ by putting their hand down into the urinal and by a combination of feeling the opening and themselves combined with being able to see the position by looking down between their legs. This may give the patient confidence that they are definitely peeing into the opening. Once self-positioned the top flaps can be closed.

The urinal is suitable for both males and females. The urinal provides a sufficient volume for peeing and can be held with a single hand during the peeing.

When seen in side view, the circumferential side wall tapers outwardly in an upward direction both in the open and in the closed position of the folding flaps.

In an embodiment, the bottom wall may be elongate, a length of the bottom wall being larger than a width of the bottom wall. This feature makes the container especially suitable to be positioned between the legs of a user and to be used as a urinal, because it results in a relatively narrow shape.

In an embodiment, the folding flaps may have a varying flap width, wherein the flap width reaches a maximum at a central portion of the folding flaps, and wherein said maximum flap width is smaller than a maximum bottom width of the bottom wall.

In an embodiment, the folding flaps may be elongate. In an embodiment, the folding flaps may have a flap length and a maximum flap width, wherein the flap length is greater than twice the maximum flap width. This provides the container with a relatively narrow shape makes it suitable to be positioned between the legs of a user.

In an embodiment, the folding flaps have a droplet shape, the folding flaps having a rounded shape at the front side and a pointy end at the rear side. In case the container is configured as a urinal, the front side has a curved shape without any sharp edges which makes it suitable to be positioned against the private parts of a user.

In an embodiment, a center of the pee opening may be located in an upper half of the front side. In this way the container conforms with the average size of the body of a grown-up male or female and the pee opening can be easily positioned directly in front of the penis or the vagina.

In an embodiment, the pee opening is closed by a pee opening flap which is connected via a pee flap fold line to an edge of the pee opening. The pee opening flap can be pushed inwards to open the pee opening, or pulled outwards.

In an embodiment, the pee flap fold line is located at an upper side of the pee opening, wherein the pee fold flap folds upward and inward during opening and acts as a splash guard when in the open position. This embodiment is specifically suitable for a female. The pee flap fold line typically is not very sharp and does not hurt the private parts of a female user.

In an embodiment, the pee flap fold line is located at a lower side of the pee opening, wherein the pee fold flap folds downward and inward, or outward, when opened, wherein in the open position of the pee fold flap and in the closed position of the folding flaps the underside of the lower folding flap is visible when looking horizontally into the container through the pee opening, wherein said underside acts as a splash guard. This embodiment is suitable for a male user. The fold line is located at the underside of the pee opening and prevents this side of the pee opening from having a relatively sharp tearing edge which could hurt the private part of the male user, in particular the testicles or the base of the penis. Folding out may be better for freshness and re-sealing whereas folding in, may be easier for positioning and comfort.

In an embodiment, the total surface area of the bottom wall may be less than 200 cm2. This allows the base to be positioned between the legs of the user.

In an embodiment, the circumferential side wall does not have sharp edges extending from the base to the upper end of the container, but provides a continuous, curved circumferential outward surface. This provides an ergonomic shape.

In an embodiment, the bottom wall has an oval shape, a circular shape, a shape of a square having rounded corners or a shape of a rectangle having rounded corners. This results in a circumferential side wall without sharp edges extending from the base to the upper end.

In an embodiment, the circumferential side wall is glued onto itself at the rear side along a seam extending from the lower and to an upper end of the rear side. Because the seam is that the rear end, it does not contact the body of the user when the container is configured as a urinal and is held between the legs of the user.

In an embodiment, the bottom wall may comprise a skirt, wherein the circumferential side wall comprises a base flap which is folded upward and inward all around the circumference, forming a U-shape into which the skirt is inserted and fixed via adhesive. This provides liquid tightness to the container.

In an embodiment, in the closed position of the folding flaps a front end of the upper end may be higher than a rear end of the upper end. This makes it possible to position the pee opening relatively high. It also provides an advantage in that an underside of the lower folding flap can act as a splash guard, in particular in the case of a male user.

In an embodiment, the container may comprise a level indicating slot covered by a transparent foil. This advantageously allows the user to see the degree of filling of the container.

In an embodiment, the container may comprise a moisture absorbing member, e.g. a sachet of gel or liquid absorbing crystals, or a pad of woven or non-woven material applied on the bottom wall. This moisture absorbing member can be located sit in the space between bottom walls of the nesting containers. For instance, if the nesting pitch is 6 mm then there is a 6 mm horizontal space. This may help to reduce spills if a patient cannot easily control the stability of the urinal. Additionally this moisture absorbing member can be used to detect and indicate the presence of blood, infection cells or drugs in the urine, etc. This may be by using a colour change or visual indication.

The present invention further relates to a method of using a container according to any of the preceding claims, the method comprising:
a) taking the container from a stack of nested containers,
b) folding the folding flaps inward and downward, thereby substantially closing the upper opening,
c) filling the container with a fluid,
wherein step b) is carried out prior to step c) or wherein step b) is carried out after step c).

The method provides substantially the same advantages as the container according to the invention.

In an embodiment of the method, step c) may comprise positioning the container between the legs of a user and peeing through a pee opening in the front side of the container.

In an embodiment, the method may further comprise a step d) of holding the container by a single hand which is placed over the upper end of the container, wherein a thumb presses against a right side or a left side of the container and one or more fingers press against the opposite side of the container.

The present invention further relates to a blank assembly configured for forming a container according to the invention, the blank assembly comprising a first blank part configured for forming the circumferential side wall and the folding flaps and a bottom wall part configured for forming the bottom wall, wherein the first blank part comprises:
a circumferential side wall section, having a varying height, wherein the height increases toward an area which is configured to form the front side of the container which is to be formed from the blank assembly,
a first folding flap section and a second folding flap section, attached to an upper end of the circumferential side wall section via respective first and second folding lines, wherein the first folding flap section and the second folding flap section are elongate, wherein the first and second folding lines are curved and curve upward in the direction of an area which is configured to form the front side of the container which is to be formed from the blank assembly, wherein the folding lines have respective front folding line ends which are located at a distance from one another, wherein a front section of the upper end of the circumferential side wall section between the front folding line ends has a curvature which is opposite to the curvature of the first and second folding lines, the front section having an apex in a central area thereof,

the bottom wall part comprising:
a central bottom wall part configured for forming the bottom wall
a circumferential bottom wall part configured for forming a skirt of the bottom wall.

The blank assembly is suitable to be formed into the container according to the invention, with the associated advantages.

In an embodiment of the blank assembly, the folding flap sections may have a maximum flap width which is smaller than a maximum bottom width of the central bottom wall part.

In an embodiment of the blank assembly, a maximum width of the folding flaps may be between 7 and 9 cm, and wherein a maximum width of the bottom wall may be greater than 10 cm. This allows the container to have sufficient volume while at the same time remaining narrow enough at the upper end to be held by the user with a single hand.

In an embodiment, the blank assembly may be configured for forming a urinal and comprises a pee opening in a front area.

In an embodiment, the bottom wall part of the blank assembly may be elongate, a length of the bottom wall part being larger than a width of the bottom wall part. This makes the container suitable to be held between the legs of a user.

In an embodiment, the folding flaps have a flap length and a maximum flap width, wherein the flap length is greater than twice the maximum flap width. This allows the container to be sufficiently narrow to be held between the legs of the user.

In an embodiment, the folding flaps have a droplet shape, the folding flaps having a rounded shape at the front end and a pointy end at the rear end. The rounded shape at the front end results in a rounded shape of the front side of the container, which is more ergonomic.

In an embodiment of the blank assembly, wherein a center of the pee opening area is located in an upper half of the front side.

In an embodiment of the blank assembly, the pee opening area is closed by a pee opening flap which is connected via a pee flap fold line to an edge of the pee opening.

In an embodiment of the blank assembly, the pee flap fold line is located at an upper side of the pee opening wherein the pee fold flap folds upward and inward, or outward during opening and acts as a splash guard when in the open position.

In an embodiment of the blank assembly, the pee flap fold line is located at a lower side of the pee opening area.

In an embodiment of the blank assembly, the total surface area of the central bottom wall part may be less than 200 cm2.

In an embodiment of the blank assembly, the bottom wall part has an oval shape, a circular shape, a shape of a square having rounded corners or a shape of a rectangle having rounded corners.

In an embodiment of the blank assembly, a height of the circumferential side wall section is greater at the area which is configured to form the front side of the container which is to be formed from the blank assembly than at the area(s) which is/are configured to form a rear side of the container which is to be formed from the blank assembly.

In an embodiment of the blank assembly, the circumferential side wall section comprises a level indicating slot covered by a transparent foil.

In an embodiment of the blank assembly, the circumferential side wall section is symmetrical about a line extending from a bottom end of the front side to an upper end of the front side.

In an embodiment, the blank assembly comprises a wall flap at a right or left edge of the circumferential side wall section. The wall flap conveniently allows the circumferential side wall section to be connected to itself.

In an embodiment, the blank assembly comprises a base flap extending along a bottom edge of the circumferential side wall section. The base flap can be folded inward and upward during the formation of the container thereby forming a U-shape. The skirt of the bottom wall part can be folded downwardly and inserted into the U-shape and connected to the U-shaped via adhesive. This provides a liquid tight connection.

In an embodiment, the first blank part and the bottom wall part are manufactured from cardboard. The cardboard can be 200-350 g/m2.

These and other aspects of the invention will be more readily appreciated as the same becomes better understood by reference to the following detailed description and considered in connection with the accompanying drawings in which like reference symbols designate like parts.

### SHORT DESCRIPTION OF THE FIGURES

FIGS. 1 and 2 show top views of two embodiments of the container according to the invention.

FIGS. 3 and 4 show side views of the two embodiments of FIGS. 1 and 2.

FIGS. 5 and 6 show front views of the two embodiments.

FIGS. 7-12 show top views of different embodiments of the container according to the invention.

FIG. 13 shows a top view of an embodiment of the container in the open state.

FIG. 14 shows a side view of this embodiment of the container in the open state.

FIG. 15 shows a front view of this embodiment of the container in the open state.

FIG. 16 shows a top view of this container in the closed state.

FIG. 17 shows a side view of this container in the closed state.

FIG. 18 shows a front view of this container in the closed state.

FIG. 19 shows a top view of a further embodiment of the container in the open state.

FIG. 20 shows a side view of the further embodiment of the container in the open state.

FIG. 21 shows a front view of the further embodiment of the container in the open state.

FIG. 22 shows a top view of the further embodiment in the closed state.

FIG. 23 shows a side view of the further embodiment in the closed state.

FIG. 24 shows a front view of the further embodiment in the closed state.

FIG. 25 shows the container when held by the user with a single hand.

FIG. 26 shows an embodiment of the container in front view.

FIG. 27 shows a stack of containers in front view.

FIG. 28 shows a stack of containers in side view.

FIG. 29 shows a further embodiment of the container.

FIG. 30 shows a further embodiment in which the container is a jug.

FIG. 31 shows a further embodiment of the container.

FIG. 32 shows a first blank part of a blank assembly for forming the container.

FIG. 33 shows a bottom part of a blank assembly for forming the container.

FIG. 34 shows a cross-sectional side view of the container.

FIG. 35 shows a detail of the bottom portion of the container.

FIG. 36 shows a sectional view of another embodiment of the invention.

### DETAILED DESCRIPTION OF THE FIGURES

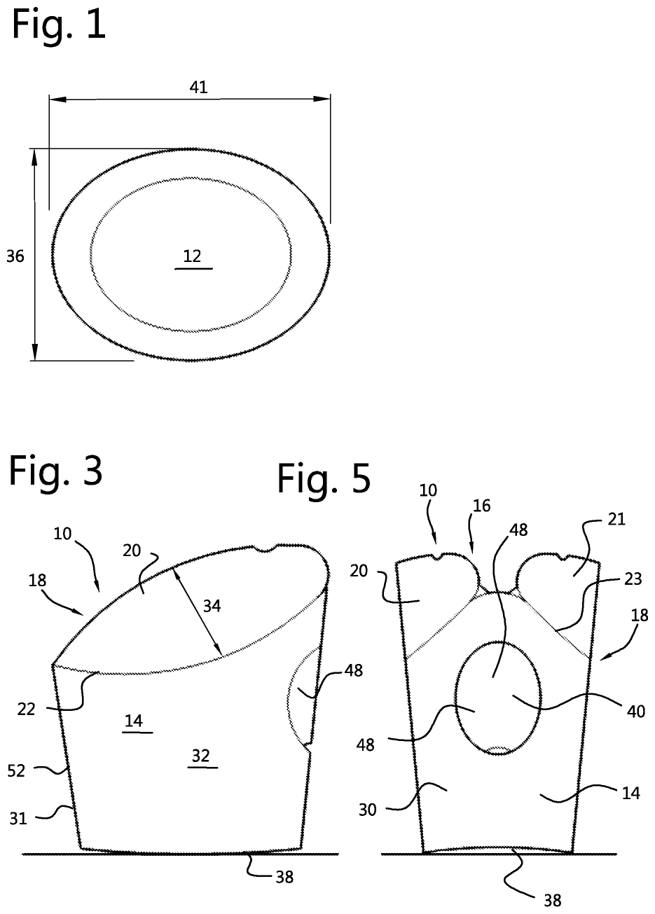

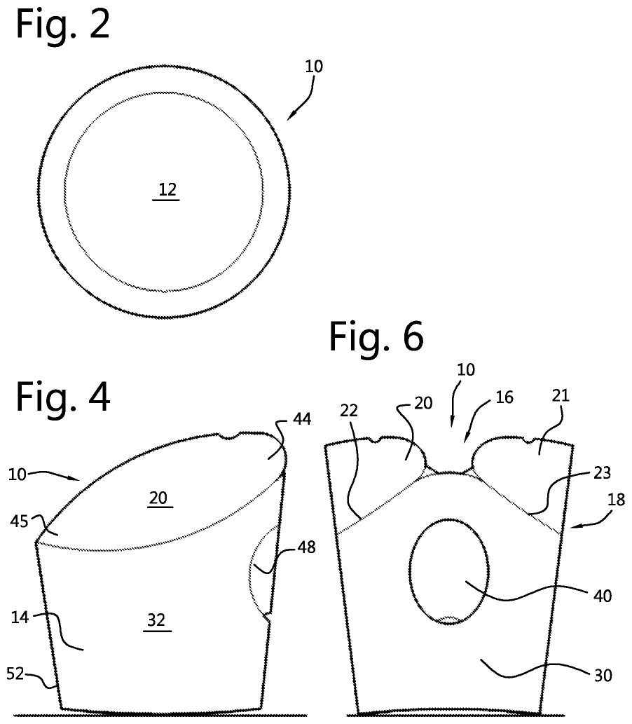

Turning to FIGS. 1-6, two different embodiments of the container 10 according to the invention are shown. The containers are typically single use, non-expandable and disposable. The container 10 is liquid tight and configured for holding a liquid, in particular a body liquid. FIGS. 1 and 2 show top views of the container in the open state. The container has a front side 30, a rear side 31, a right side 32 and a left side 33.

The container comprises a bottom wall 12 and a circumferential side wall 14 which extends in an upward direction from the bottom wall. The circumferential side wall defines an upper opening 16 at an upper end 18 of the container.

The container 10 comprises a first folding flap 20 and a second folding flap 21 which are connected via a respective first folding line 22 and a second folding line 23 to opposed sections of an upper edge 24 of the circumferential side wall. The folding flaps 20, 21 are elongate. The first and second folding flaps are foldable between an position in which the upper opening is open and a closed position in which the upper opening is substantially closed.

In the open state, the containers taper outwardly, allowing the containers to be stacked. This reduces the total storage volume which is in particular important when a large number of containers need to be stored.

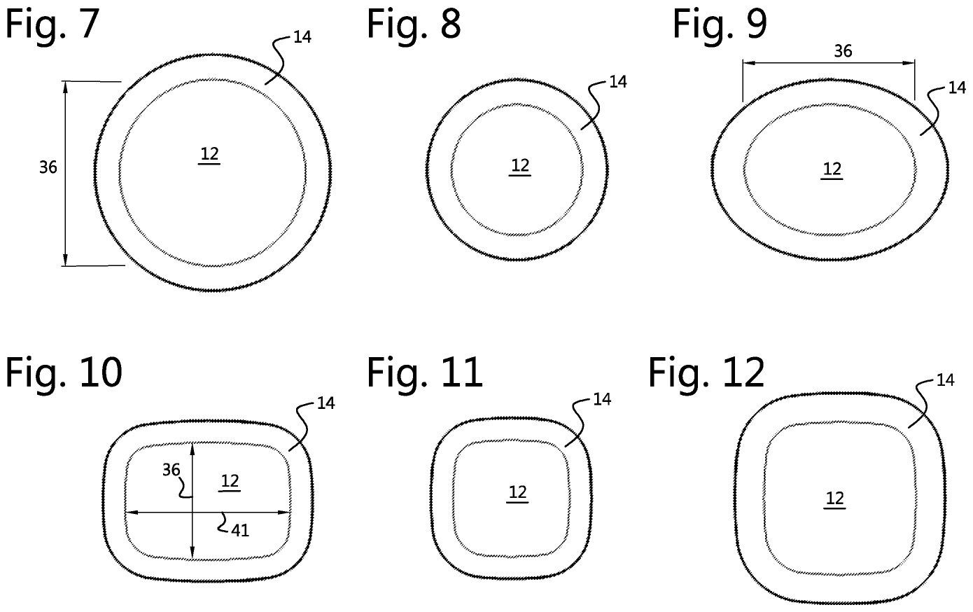

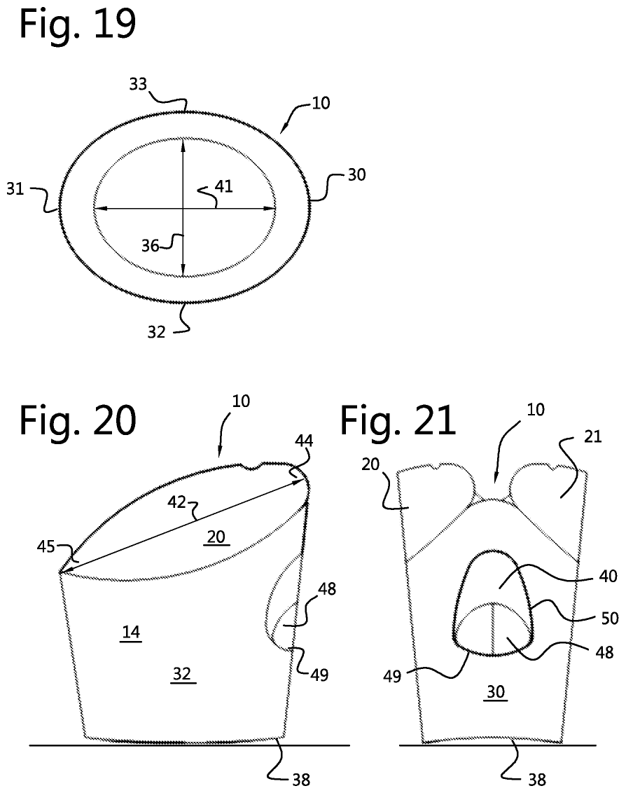

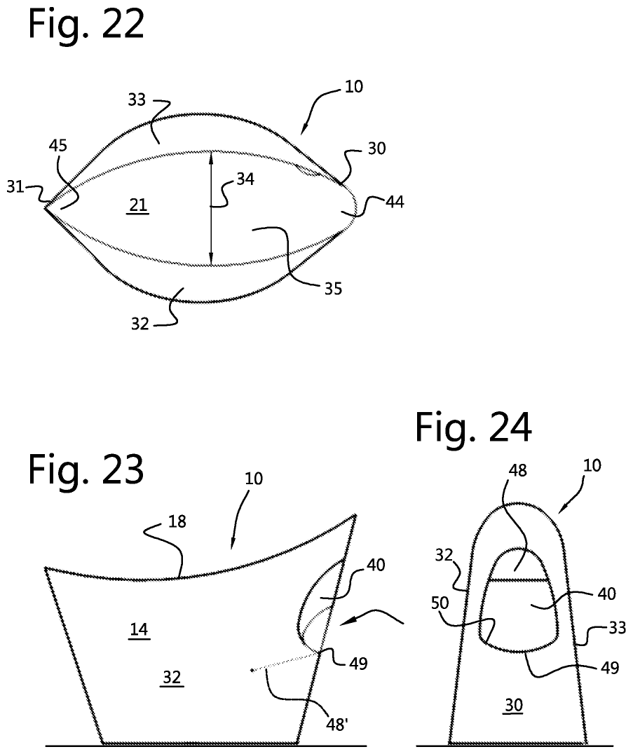

Turning to FIGS. 7 through 12, various shapes of the bottom wall 12 are possible. FIGS. 7 and 8 show circular bottom walls 12 having different diameters. FIG. 9 shows an oval bottom wall 12. FIG. 10 shows a rectangular bottom wall having rounded corners. FIGS. 11 and 12 show square bottom walls having rounded corners. In the embodiments of FIGS. 1, 9, 10, 13-24, the bottom wall 12 is elongate, a length 41 of the bottom wall 12 being larger than a width 36 of the bottom wall 12. The total surface area of the bottom wall 12 may be less than 200 cm2.

In all the shown versions, the circumferential side wall 14 does not have any sharp edges extending from the base to the upper end, but provides a continuous, smooth, curved circumferential outward surface.

The circumferential side wall 14 is glued onto itself at the rear side along a seam 52 extending from the lower and to an upper end of the rear side. The circumferential side wall 14 at the seam 52 is also relatively smooth.

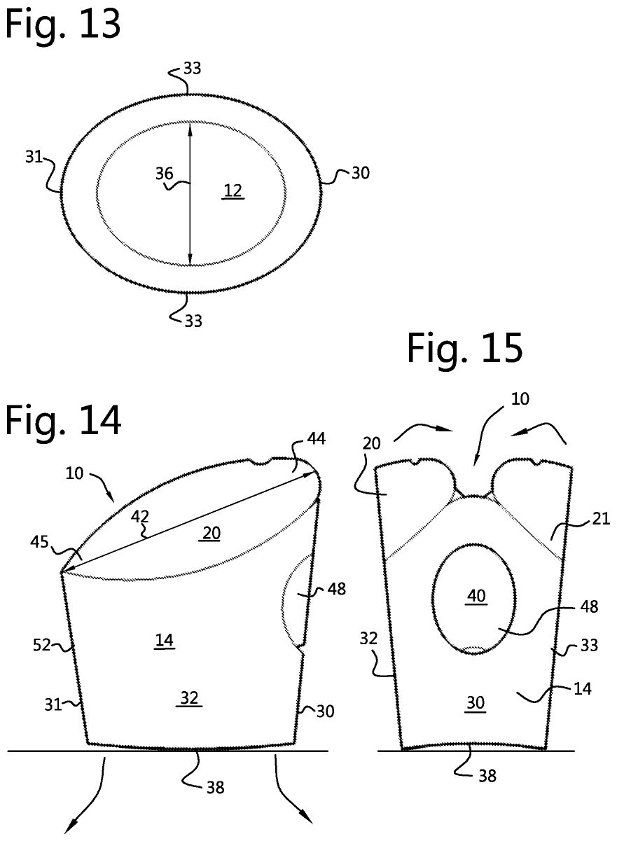

Turning to FIGS. 13 through 15, the container 10 tapers outwardly in an upper direction when the folding flaps 20, 21 are in the open position. In the open position, the following flaps are aligned with the circumferential side wall 14. Turning to FIGS. 16, 17 and 18 when the folding flaps 20, 21 are closed, the tapering angle reverses, when the container is seen in front view. The following flaps 20, 21 are folded over one another, wherein either the first folding flap 20 or the second folding flap 21 can be closed first. In front view, the tapering angle becomes negative, with the result that the upper end is narrower than the bottom of the container. In side view, the tapering angle actually increases when the folding flaps are closed. This is a result of the deformation of the circumferential side wall, which is caused by the inwardly folding flaps having a relatively small width.

In this embodiment, the upper end 18 of the container is higher at a front side 26 of the upper end than in a central portion 28 thereof.

In the closed position of the folding flaps 20,21 the upper end 18 of the container has a concave shape.

The folding flaps 20, 21 have a varying flap width 34. The flap width 34 reaches a maximum at a central portion 35 of the folding flaps. Said maximum flap width is smaller than a bottom width 36 of the bottom wall 12. The folding flaps may have a flap length 42 and a maximum flap width 34. The flap length 42 may be greater than twice the maximum flap width 34. The folding flaps 20, 21 may have a droplet shape, the folding flaps having a rounded shape at the front end 44 of the folding flaps and a pointy end at the rear end 45 of the folding flaps.

During the folding of the folding flaps 20, 21 from the open position to the closed position the folding flaps are deformed from a convex shape to a concave shape.

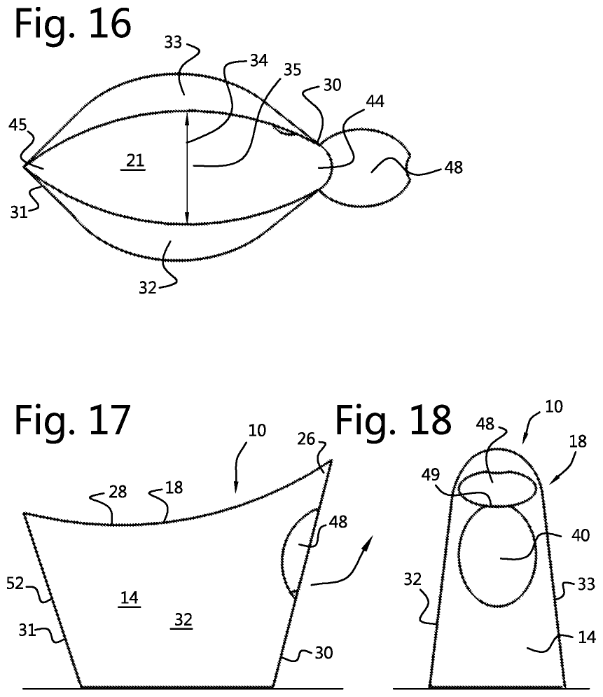

When seen in front view, during the folding of the folding flaps from the open position to the closed position, the circumferential side wall deforms from the outwardly tapering form to an inwardly tapering form. This is visible by comparing FIGS. 15 and 18, and by comparing FIGS. 21 and 24. When seen in front view in the open position of the folding flaps the tapering angle of the circumferential side wall is 3-7 degrees outward (FIGS. 15, 21) and wherein in the closed position of the folding flaps the tapering angle of the circumferential side wall is 3-20 degrees inward (FIGS. 18, 24).

When seen in side view, the circumferential side wall 14 tapers outwardly in an upward direction both in the open and in the closed position of the folding flaps 20, 21.

With reference to FIGS. 14 and 20, in the open position of the folding flaps 20, 21 the bottom wall 12 and the lower edge 38 of the circumferential side wall have a rocker shape (or convex shape) when seen in side view of the container. With reference to FIGS. 15 and 21, in the open position of the folding flaps 20,21 the bottom wall and the lower edge 38 of the circumferential side wall 14 have a camber shape (or concave shape) when seen in front view of the container.

With reference to FIGS. 17,18, 23 and 24, during the folding of the folding flaps 20, 21 from the open position to the closed position the bottom wall and the lower edge of the circumferential side wall are deformed from the rocker shape into a substantially flat shape. Also, during the folding of the folding flaps from the open position to the closed position the bottom wall 12 and the lower edge 38 of the circumferential side wall 14 are deformed from the camber shape into a substantially flat shape. The camber and rocker shape are also visible in FIGS. 3,4,5 and 6.

A maximum width 34 of the folding flaps 20, 21 may be between 7 and 9 cm, and a maximum width 36 of the bottom wall 12 may be greater than 10 cm.

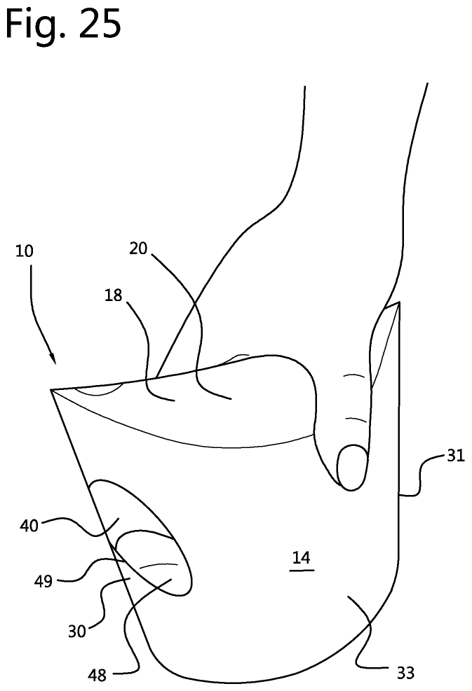

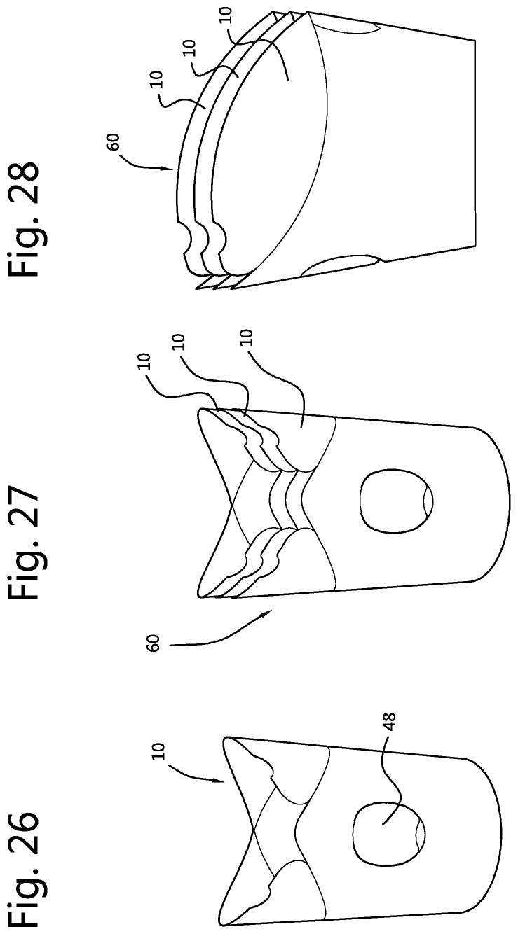

In the embodiment shown in FIGS. 1-28, the container is a urinal and comprises a pee opening 40 in the front side 30. A center 46 of the pee opening 40 is located in an upper half of the front side.

The pee opening 40 is (initially) closed by a pee opening flap 48 which is connected via a pee flap fold line 49 to an edge 50 of the pee opening. The pee opening can be opened by pushing the flap inward or pulling it outward. The rest of the contour of the pee opening flap is connected to the circumferential side wall via a tear line.

With reference to the embodiment of FIGS. 1-6 and 13-18, the pee flap fold line 49 is located at an upper side of the pee opening, wherein the pee fold flap 48 folds upward and inward during opening and acts as a splash guard when in the open position. This embodiment is in particular suitable for females.

In an alternative embodiment shown in FIGS. 20-24, the pee flap fold line 49 is located at a lower side of the pee opening, wherein the pee fold flap 48 folds downward and inward when opened, wherein in the open position of the pee fold flap and in the closed position of the folding flaps the underside of the lower folding flap is visible when looking horizontally into the container through the pee opening, wherein said underside acts as a splash guard.

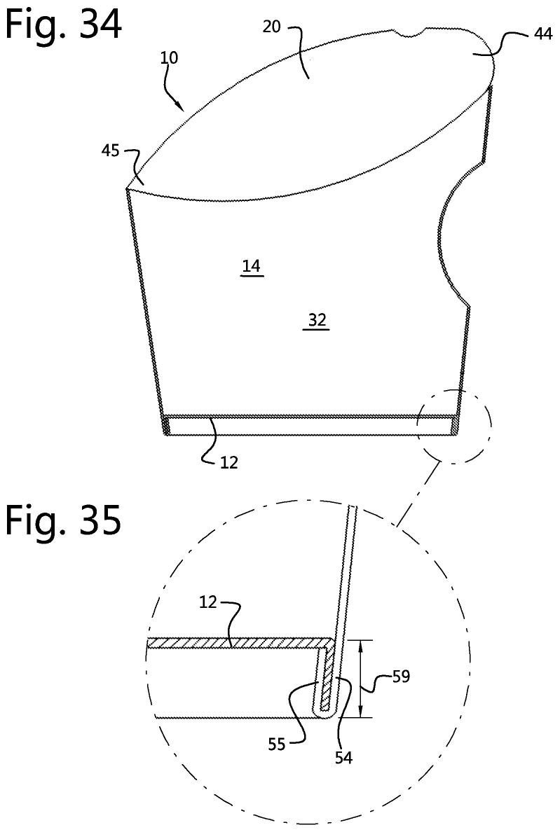

With reference to FIGS. 34 and 35, the bottom wall 12 comprises a skirt 54, wherein the circumferential side wall 14 comprises a base flap 55 which is folded upward and inward, forming a U-shape into which the skirt is inserted and fixed via adhesive. The skirt may have a height 59 of 4-10 mm. The base flap 55 of the side wall 14 is folded around the skirt all around the circumference. This overlapping creates a liquid tight ‘labyrinth seal’.

The height 59 creates a volume between the bottom walls 12 of nested containers

With reference to FIGS. 27 and 28, the container is stackable into a stack 60 of nested containers. This reduces storage volume.

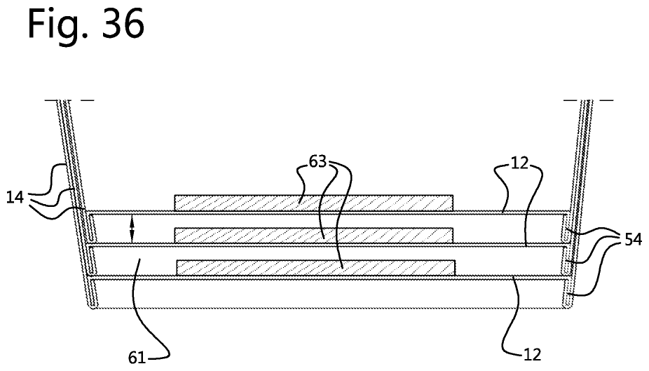

With reference to FIG. 36, a stack of three containers is shown. The volume 61 between the bottom walls 12 of the nested container may be used to insert a moisture absorbing member 63 in the container, which can be attached to the bottom wall 12 of the associated container. The moisture absorbing member may be a sachet of gel or liquid absorbing crystals, or a pad of woven or non-woven material applied on the bottom wall.

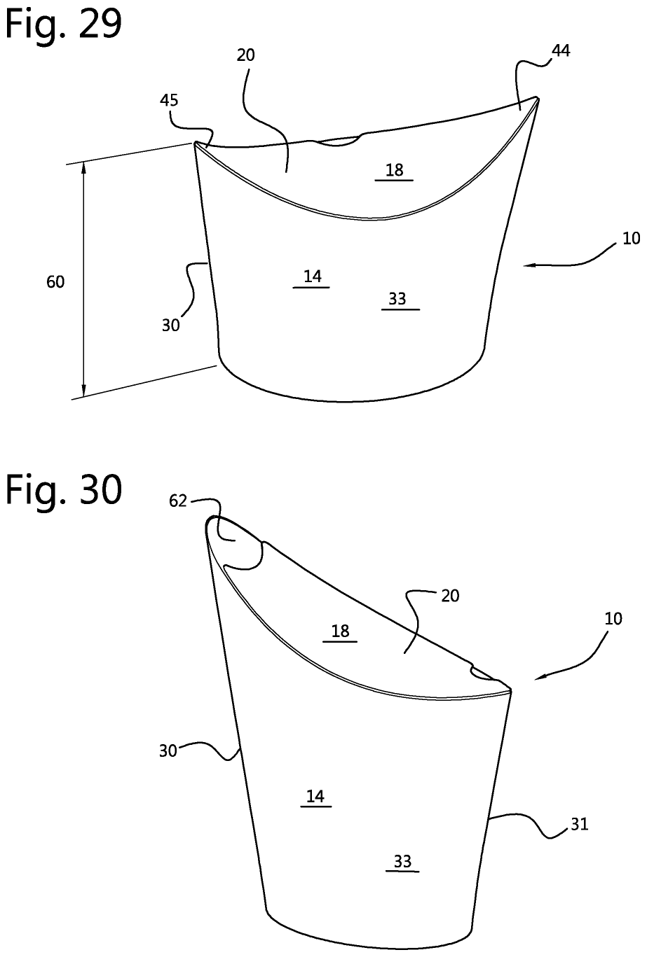

With reference to FIG. 29, an embodiment is shown in which the front end 44 and the rear end 45 of the upper end 18 have a same height 60, measured from the base, and wherein in particular the container has no pee opening. This embodiment is suitable as a vomit bag, but also for more general purposes. The front side 30 may actually become the right or left side in use, but for consistency with the other figures is referred to as the front side. Both ends 44, 45 of the folding flaps 20, 21 may be curved or pointy.

With reference to FIG. 30, and embodiment is shown in which the container 10 is a jug and the folding flaps comprise a cut-out 62 at a front end thereof. The cut-out 62 allows pouring of a liquid from the container. This embodiment can be used for various purposes. In this embodiment the front side is higher than the rear side. This embodiment has no pee opening.

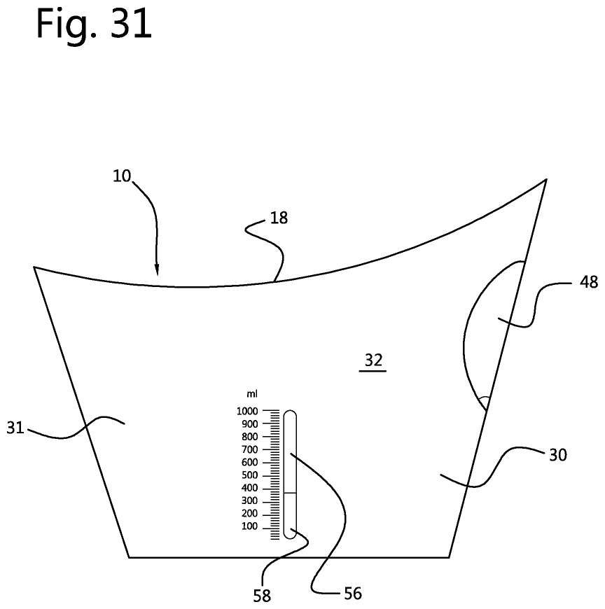

With reference to FIG. 31, in an embodiment the container 10 may comprise a level indicating slot 56 covered by a transparent foil 58.

The embodiments of FIGS. 29-31 also have the change in tapering angle from outward to inward.

### Operation

In operation, the container may be used as follows. First, the user takes one container from a stack 60 of containers, see FIGS. 27 and 28. Next, the user folds the folding flaps 20, 21 inward and downward, thereby substantially closing the upper opening 16. Next, the container is filled with a liquid, in particular a body liquid.

If the container 10 is a vomit bowl it will be filled with vomit prior to closing the folding flaps. If the container is another kind of container which is to be filled via the upper opening, naturally it will also be filled before closing the folding flaps.

If the container is a urinal, it will be filled after closing the folding flaps. The pee flap 48 will be opened, in particular by pushing it inwards, or pulling it outwards. In that case step c) will comprise positioning the container between the legs of a user and peeing through the pee opening 40 in the front side 30 of the container.

During the peeing, the container may be held by a single hand which is placed over the upper end of the container, wherein a thumb presses against a right side or a left side of the container and one or more fingers press against the opposite side of the container. After the peeing is done, the container may be lifted from the position between the legs by the same single hand. The pee flap 48 may be closed.

### Blank Assembly

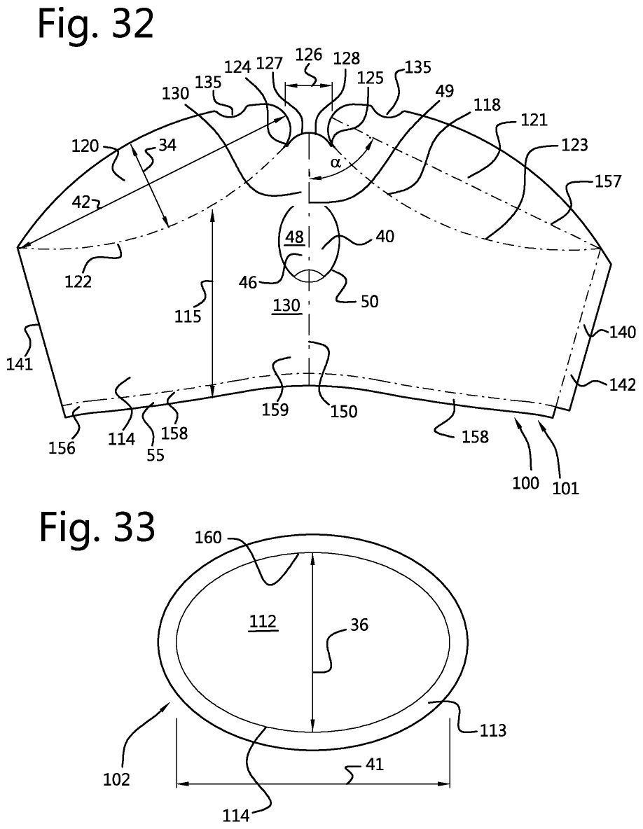

Turning to FIGS. 31 and 32, the present invention further relates to a blank assembly 100 configured for forming the container 10 according to the invention. The blank assembly comprises a first blank part 101 configured for forming the circumferential side wall 14 and the folding flaps 20, 21 and a bottom wall part 102 configured for forming the bottom wall 12. The blank assembly 100 may comprise only these two parts. The first blank part and the bottom wall part are manufactured from cardboard.

The first blank part 101 comprises a circumferential side wall section 114 having a varying height 115. The height increases toward an area 130 which is configured to form the front side 30 of the container which is to be formed from the blank assembly. The first blank part 101 comprises a right edge 140 and a left edge 141. The right edge comprises a wall flap 142 which allows the right edge to be connected to the left edge.

A base flap 55 extends along a lower edge 156 of the circumferential side wall section 114. The lower edge 156 is curved and comprises rocker sections 158 having an upward curvature. The lower edge 156 comprises a camber section 159 at the front side.

The first blank part 101 further comprises a first folding flap section 120 and a second folding flap section 121, which are attached to an upper end 118 of the circumferential side wall section via a respective first folding line 122 and a second folding line 123. The curvature of the folding lines 122, 123 is less than the curvature of the right side 160 and left side 161 of the bottom wall part 102.

The first folding flap section 120 and the second folding flap section 121 are elongate. The first and second folding lines are curved and curve upward in the direction of an area 130 which is configured to form the front side of the container which is to be formed from the blank assembly. The folding flap sections 120, 121 have a flap length 42 and a maximum flap width 34, and the flap length is greater than twice the maximum flap width. The folding flap sections 120, 121 have a droplet shape, the folding flaps having a rounded shape at the front side and a pointy end at the rear side. However, it is also possible that at the rear side.

The folding flap sections 120, 121 may each have a cut-out 135.

The folding lines 122, 123 have respective front folding line ends 124,125 which are located at a distance 126 from one another. A front section 127 of the upper end of the circumferential side wall section between the front folding line ends 124, 125 has a curvature which is opposite to the curvature of the first and second folding lines. The front section 127 has an apex 128 in a central area thereof.

The circumferential side wall section 114 is symmetrical about a line 150 extending from a bottom end of the front side to an upper end of the front side and which divides the part 101 in a left half and a right half.

Each folding flap section 120,121 has a longitudinal axis 157. The longitudinal axis 157 extends at an angle α of about 60-85 degrees to the line 150.

The bottom wall part 102 comprises a central bottom wall 112 part configured for forming the bottom wall and a circumferential bottom wall part 113 configured for forming a skirt of the bottom wall. The central bottom wall 112 and the circumferential bottom wall part 113 are connected to one another via a bottom wall folding line 114. In this embodiment, the bottom wall part is elongate, a length of the bottom wall part being larger than a width of the bottom wall part. It is noted that the circumferential bottom wall part 113 is not included in the length or width, because it is intended to form the skirt.

The total surface area of the central bottom wall part 112 may be less than 200 cm2.

The bottom wall part 102 has an oval shape, but a circular shape, a shape of a square having rounded corners or a shape of a rectangle having rounded corners is also possible.

A maximum width 34 of the folding flaps is between 7 and 9 cm, and a maximum width 36 of the bottom wall is greater than 10 cm.

The blank assembly 100 is configured for forming a urinal and comprises a pee opening 40 in a front area. A center 46 of the pee opening area is located in an upper half of the front side. The pee opening area is closed by a pee opening flap 48 which is connected via a pee flap fold line 49 to an edge 50 of the pee opening. The pee flap fold line 49 is located at an upper side of the pee opening. In use, the pee fold flap 48 folds upward and inward during opening and acts as a splash guard when in the open position. Alternatively, it can be pulled up and outward.

In another embodiment, the pee flap fold line may be located at a lower side of the pee opening area.

The circumferential side wall section may comprises a level indicating slot covered by a transparent foil.

It will be clear that the description above is intended to illustrate the operation of preferred embodiments of the invention, and not to reduce the scope of protection of the invention. Starting from the above description, many embodiments will be conceivable to the skilled person within the inventive concept and scope of protection of the present invention.

1-47. (canceled)

48. A single use, non-expandable, disposable container for holding a liquid, in particular a body liquid, the container comprising:
a bottom wall,
a circumferential side wall which extends in an upward direction from the bottom wall, wherein the circumferential side wall defines an upper opening at an upper end of the container,
a first folding flap and a second folding flap which are connected via a respective first folding line and a second folding line to opposed sections of an upper edge of the circumferential side wall, wherein the first and second folding flaps are foldable between an open position in which the upper opening is open and a closed position in which the upper opening is substantially closed and in which the first and second folding flap are folded over another,
wherein in the open position of the folding flaps the circumferential side wall and the folding flaps taper outwardly in an upward direction and the folding flaps are substantially aligned with the circumferential side wall, allowing the container to be nested, and
wherein the container has a front side, a rear side, a right side, and a left side, wherein in the closed position of the folding flaps the upper end of the container has a concave shape,
wherein during the folding of the folding flaps from the open position to the closed position the folding flaps are deformed, and
wherein when seen in front view, during the folding of the folding flaps from the open position to the closed position, the circumferential side wall deforms from the outwardly tapering form to an inwardly tapering form.

49. The container according to claim 48, wherein when seen in front view in the open position of the folding flaps the tapering angle of the circumferential side wall is 3-7 degrees outward, and wherein in the closed position of the folding flaps the tapering angle of the circumferential side wall is 3-20 degrees inward.

50. The container according to claim 48, wherein the folding flaps have a maximum flap width which is smaller than a maximum bottom width of the bottom wall.

51. The container according to claim 48, wherein in the open position of the folding flaps the bottom wall and the lower edge of the circumferential side wall have a rocker shape when seen in side view of the container, wherein during the folding of the folding flaps from the open position to the closed position the bottom wall and the lower edge of the circumferential side wall are deformed from the rocker shape into a substantially flat shape and wherein in the open position of the folding flaps the bottom wall and the lower edge of the circumferential side wall have a camber shape when seen in front view of the container, wherein during the folding of the folding flaps from the open position to the closed position the bottom wall and the lower edge of the circumferential side wall are deformed from the camber shape into a substantially flat shape.

52. The container according to claim 48, wherein the container is a urinal and comprises a pee opening in the front side.

53. The container according to claim 48, wherein the bottom wall has an oval shape, a circular shape, a shape of a square having rounded corners, or a shape of a rectangle having rounded corners.

54. The container according to claim 48, wherein the bottom wall comprises a skirt, wherein the circumferential side wall comprises a base flap which is folded upward and inward all around the circumference, forming a U-shape into which the skirt is inserted and fixed via adhesive.

55. The container according to claim 48, wherein in the closed position of the folding flaps a front end of the upper end of the container is higher than a rear end of the upper end of the container.

56. The container according to claim 48, wherein the front end and the rear end of the upper end have a same height.

57. A single use, non-expandable, disposable container for holding a liquid, in particular a body liquid, the container comprising:
a bottom wall,
a circumferential side wall which extends in an upward direction from the bottom wall, wherein the circumferential side wall defines an upper opening at an upper end of the container,
a first folding flap and a second folding flap which are connected via a respective first folding line and a second folding line to opposed sections of an upper edge of the circumferential side wall, wherein the first and second folding flaps are foldable between an open position in which the upper opening is open and a closed position in which the upper opening is substantially closed and in which the first and second folding flap are folded over another,
wherein in the open position of the folding flaps the circumferential side wall and the folding flaps taper outwardly in an upward direction and the folding flaps are substantially aligned with the circumferential side wall, allowing the container to be nested, and
wherein the container has a front side, a rear side, a right side, and a left side, wherein in the closed position of the folding flaps the upper end of the container has a concave shape,
wherein during the folding of the folding flaps from the open position to the closed position the folding flaps are deformed, and
wherein the container is a urinal and comprises a pee opening in the front side.

58. A single use, non-expandable, disposable container for holding a liquid, in particular a body liquid, the container comprising:
a bottom wall,
a circumferential side wall which extends in an upward direction from the bottom wall, wherein the circumferential side wall defines an upper opening at an upper end of the container,
a first folding flap and a second folding flap which are connected via a respective first folding line and a second folding line to opposed sections of an upper edge of the circumferential side wall, wherein the first and second folding flaps are foldable between an open position in which the upper opening is open and a closed position in which the upper opening is substantially closed and in which the first and second folding flap are folded over another,
wherein in the open position of the folding flaps the circumferential side wall and the folding flaps taper outwardly in an upward direction and the folding flaps are substantially aligned with the circumferential side wall, allowing the container to be nested, and
wherein the container has a front side, a rear side, a right side, and a left side, wherein in the closed position of the folding flaps the upper end of the container has a concave shape,
wherein during the folding of the folding flaps from the open position to the closed position the folding flaps are deformed, and
wherein the bottom wall comprises a skirt, wherein the circumferential side wall comprises a base flap which is folded upward and inward all around the circumference, forming a U-shape into which the skirt is inserted and fixed via adhesive.
